(19) United States
(12) Patent Application Publication
(10) Pub. No.: US 2026/0134290 A1
(43) Pub. Date: May 14, 2026

(54) METHOD AND APPARATUS WITH MODEL GENERATION

(71) Applicant: Samsung Electronics Co., Ltd., Suwon-si (KR)

(72) Inventors: Jihye KIM, Suwon-si (KR); Jaehyup LEE, Suwon-si (KR); Seon Min RHEE, Suwon-si (KR)

(73) Assignee: Samsung Electronics Co., Ltd., Suwon-si (KR)

(21) Appl. No.: 19/381,078

(22) Filed: Nov. 6, 2025

(30) Foreign Application Priority Data
Nov. 12, 2024 (KR) 10-2024-0160313

(51) Int. Cl. G06N 3/096; G06N 3/045

(52) U.S. Cl. CPC G06N 3/096; G06N 3/045

(57) ABSTRACT

A processor-method including identifying a first uncertainty associated with a plurality of first neural network models based on a plurality of pieces of output information obtained from identical input information for each model of the plurality of first neural network models and a second uncertainty due to noise in the input information, determining a distillation loss based on the first uncertainty and the second uncertainty, and generating a second neural network model based on knowledge distillation using the distillation loss.

### CROSS-REFERENCE TO RELATED APPLICATIONS

This application claims the benefit under 35 USC § 119(a) of Korean Patent Application No. 10-2024-0160313, filed on Nov. 12, 2024, in the Korean Intellectual Property Office, the disclosure of which is incorporated herein by reference for all purposes.

### BACKGROUND

### 1. Field of the Invention

The following description relates to a method and apparatus with model generation.

### 2. Description of the Related Art

As the complexity of neural network models such as deep learning increases and the number of industries utilizing them increases, an uncertainty, which indicates the level of the confidence in the inference results, and inferences through neural network models are being studied. There are different types of uncertainty, and different ways to estimate different uncertainties. Accordingly, there is a desire to generate neural network models with improved performance by taking into account estimated uncertainties.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including identifying a first uncertainty associated with a plurality of first neural network models based on a plurality of pieces of output information obtained from identical input information for each model of the plurality of first neural network models and a second uncertainty due to noise in the input information, determining a distillation loss based on the first uncertainty and the second uncertainty, and generating a second neural network model based on knowledge distillation using the distillation loss.

The identifying the first uncertainty and the second uncertainty may include identifying respective means of a plurality of pieces of output information corresponding to each of the plurality of first neural network models and identifying the first uncertainty based on respective variances of the respective means corresponding to each of the plurality of first neural network models.

The identifying the first uncertainty and the second uncertainty further may include identifying respective variances of the plurality of pieces of output information corresponding to each of the plurality of first neural network models and identifying the second uncertainty based on a mean of the respective variances corresponding to each of the plurality of first neural network models.

The determining the distillation loss includes determining the distillation loss based one or more of the first uncertainty, the second uncertainty, a first loss corresponding to a first difference between ground-truth (GT) information corresponding to the input information provided to the second neural network model and output information of the second neural network model, and a second loss corresponding to a second difference between the output information of the first neural network models and the output information of the second neural network model.

The determining the distillation loss may include determining the distillation loss based on calculation based on the first uncertainty, the first loss and the second loss.

The determining the distillation loss may include controlling a ratio between the first loss and the second loss based on the second uncertainty and determining the distillation loss based on a first value of the first uncertainty and an adjusted ratio between the first loss and the second loss based on the second uncertainty.

The determining the distillation loss further may include determining the distillation loss based on calculation between the first uncertainty and the first loss responsive to a second value of the second uncertainty being greater than a threshold value.

The generating the second neural network model may include generating a plurality of second neural network models and a first number of first neural network models may be greater than a second number of the plurality of second neural network models.

The generating the second neural network model may include generating the second neural network model having a first uncertainty, based on the knowledge distillation using the distillation loss, the first uncertainty of the second neural network model being lower than the first uncertainty of the plurality of first neural network models.

In a general aspect, here is provided a non-transitory computer-readable storage medium storing instructions that, when executed by a processor, cause the processor to perform the method.

In a general aspect, here is provided an electronic device including a processor configured to execute instructions, a memory storing the instructions, and execution of the instructions configures the processors to identify a first uncertainty associated with a plurality of first neural network models based on a plurality of pieces of output information obtained from identical input information for each model of the plurality of first neural network models and a second uncertainty due to noise inherent in the input information, determine a distillation loss based on the first uncertainty and the second uncertainty, and generate a second neural network model based on knowledge distillation using the distillation loss.

The processor may be further configured to identify respective means of a plurality of pieces of output information corresponding to each of the plurality of first neural network models and identify the first uncertainty based on respective variances of the respective means corresponding to each of the plurality of first neural network models.

The processor may be further configured to identify respective variances of the plurality of pieces of output information corresponding to each of the plurality of first neural network models and identify the second uncertainty based on a mean of the respective variances corresponding to each of the plurality of first neural network models.

The processor may be further configured to determine the distillation loss based on one or more of the first uncertainty, the second uncertainty, a first loss corresponding to a first difference between GT information corresponding to the input information provided to the second neural network model and output information of the second neural network model, and a second loss corresponding to a second difference between the output information of the first neural network models and the output information of the second neural network model.

The processor may be further configured to determine the distillation loss based on calculation based on the first uncertainty, the first loss and the second loss.

The processor may be further configured to control a ratio between the first loss and the second loss based on the second uncertainty and determine the distillation loss based on a first value of the first uncertainty and an adjusted ratio between the first loss and the second loss based on the second uncertainty.

The processor may be further configured to determine the distillation loss based on calculation between the first uncertainty and the first loss responsive to a second value of the second uncertainty being greater than a threshold value.

The processor may be further configured to generate a second number of a plurality of second neural network models, the second number being less than a first number of the plurality of first neural network models.

The processor may be further configured to generate the second neural network model having a first uncertainty, based on the knowledge distillation using the distillation loss, the first uncertainty of the second neural network model being lower than the first uncertainty of the plurality of first neural network models.

In a general aspect, here is provided a processor-implemented method including obtaining target information, processing the target information using a second neural network model that is generated based on a plurality of first neural network models, and the second neural network model includes a first uncertainty, the first uncertainty of the second neural network model being less thana first uncertainty of a plurality of first neural network models, between the first uncertainty of the plurality of first neural network models and a second uncertainty due to noise in training data.

Effects of the present disclosure are not limited to those described above, and other effects may be made apparent to those skilled in the art from the following description.

### BRIEF DESCRIPTION OF THE FIGURES

FIG. 1 illustrates an example knowledge distillation process between a first neural network model and a second neural network model according to one or more embodiments.

FIG. 2 illustrates an example method of setting a distillation loss used in knowledge distillation according to one or more embodiments.

FIG. 3 illustrates an example method of outputting information for each of a plurality of first neural network models for the same input information according to one or more embodiments.

FIG. 4 illustrates an example method estimating a first uncertainty and a second uncertainty based on a plurality of first neural network models according to one or more embodiments.

FIG. 5 illustrates an example method of generating a second neural network model generated based on a knowledge distillation according to one or more embodiments.

FIG. 6 illustrates an example method of model generation according to one or more embodiments.

FIG. 7 illustrates an example method of information processing using a neural network model according to one or more embodiments.

FIG. 8 illustrates an example electronic device according to one or more embodiments.

FIG. 9 illustrates an example computing system including a computational device according to one or more embodiments.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

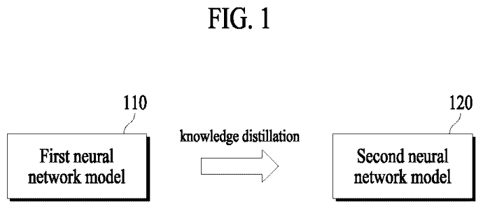

FIG. 1 illustrates an example knowledge distillation process between a first neural network model and a second neural network model according to one or more embodiments.

In an example, a neural network model may include an input layer, one or more hidden layers and an output layer. The input layer may receive input information and pass the input information to the hidden layers, and the output layer may generate output information of the neural network model based on signals received from the nodes of the hidden layers. The input layer, one or more hidden layers, and the output layer may contain at least one node. Here, at least one node included in the input layer and one or more hidden layers may be connected to each other via a connecting line having a connection weight, and at least one node in the hidden layers and the output layer may also be connected to each other via a connecting line having a connection weight. Here, the connection weights may be trained and updated by algorithms such as back propagation. The neural network models may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), or Deep Q-Networks. However, the neural network models are not limited thereto.

Referring to FIG. 1, in a non-limiting example, a second neural network model 120 may be generated from a first neural network model 110 by applying a knowledge distillation. Knowledge distillation may propagate knowledge between different neural network models.

For example, the first neural network model 110 may correspond to a teacher model, the second neural network model 120 may correspond to a student model, and the student model may be generated from a teacher model by applying the knowledge distillation.

Here, by the knowledge distillation, the second neural network model 120 may be a lightweight model compared to the first neural network model 110. For example, the student model may be a lightweight model that contains fewer layers and nodes compared to the teacher model.

Hereinafter, examples are described in which the second neural network model 120 is generated from the first neural network model 110 based on the knowledge distillation.

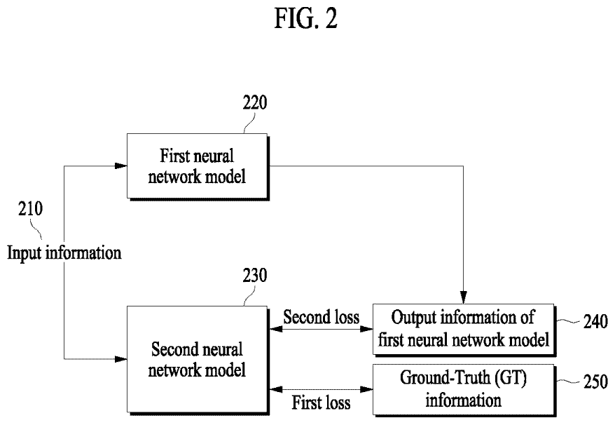

FIG. 2 illustrates an example method of setting a distillation loss used in knowledge distillation according to one or more embodiments.

Referring to FIG. 2, in a non-limiting example, a second neural network model 230 may be generated from a first neural network model 220 by applying knowledge distillation based on distillation loss.

In an example, factors including a first loss, a second loss, a first uncertainty, and a second uncertainty may be used in the process of setting the distillation loss. The second neural network model 230 may be generated from the first neural network model 220 using the distillation loss determined based on at least one of the first loss, the second loss, the first uncertainty, and the second uncertainty.

In an example, the first loss may correspond to the difference between the Ground-Truth (GT) information 250 corresponding to input information 210 and output information of the second neural network model 230, and the second loss may correspond to the difference between output information 240 of the first neural network model and the output information of the second neural network model 230.

Meanwhile, with respect to the uncertainty of the neural network model itself, the first uncertainty may be the uncertainty about how accurately the neural network model has learned the input information 210. The first uncertainty may occur when a neural network model is trained based on limited information that is insufficient or based on information that lacks diversity. Accordingly, the first uncertainty may be reduced by increasing the amount of training data, including diverse information in the training data, or adjusting the structure and parameters of the neural network model. The first uncertainty may correspond to epistemic uncertainty.

Further, the second uncertainty may be the uncertainty of the data itself. For example, the second uncertainty is uncertainty that occurs based on collected information due to noise, measurement error, environmental fluctuations, and so on due to errors or defects in sensors or measuring equipment. Unlike the first uncertainty, which may be improved by increasing the amount of training data, the second uncertainty may not be improved even if training is performed using more information containing the same level of noise. This second uncertainty may correspond to the aleatoric uncertainty that arises during the data collection process.

Hereinafter described are examples with reference to other drawings in which the second neural network model 230 is generated from the first neural network model 220 using the distillation loss determined based on at least one of the first loss, the second loss, the first uncertainty and the second uncertainty.

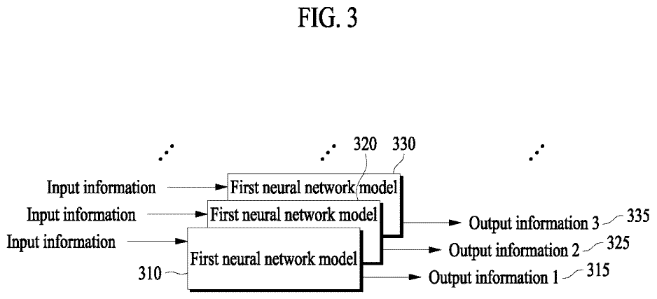

FIG. 3 illustrates an example method of outputting information for each of a plurality of first neural network models for the same input information according to one or more embodiments.

Referring to FIG. 3, in a non-limiting example, a plurality of first neural network models 310, 320 and 330 may be neural network models trained with training data. However, the plurality of first neural network models 310, 320 and 330 are an example and the scope of the present specification is not limited thereto.

Here, even if identical information is input to the plurality of first neural network models, the output information may not be identical. For example, even if identical input information is input to each model of the plurality of first neural network models 310, 320 and 330, their resulting first output information 315, second output information 325 and third output information 335 may not be identical.

In other words, the plurality of first neural network models 310, 320 and 330 may provide different first output information 315, the second output information 325 and the third output information 335 for the identical input information whenever the training data changes. However, in an example, a mean and the variance of the plurality of pieces of output information 315, 325, and 335 may be determined.

In an example, the first uncertainty and the second uncertainty may be estimated based on the mean and the variance of the plurality of pieces of output information. Hereinafter, examples are described in which the first uncertainty and the second uncertainty are estimated based on the plurality of pieces of output information of a plurality of first neural network models.

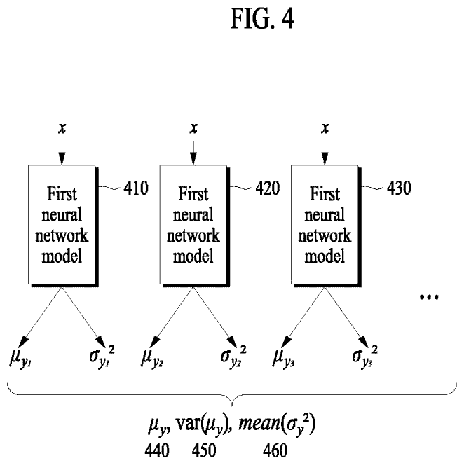

FIG. 4 illustrates an example method estimating a first uncertainty and a second uncertainty based on a plurality of first neural network models according to one or more embodiments.

Referring to FIG. 4, in a non-limiting example, a plurality of first neural network models may include a first neural network model 410, a first neural network model 420 and a first neural network model 430, each being trained by corresponding training data. Here, the first neural network model 410, the first neural network model 420 and the first neural network model 430 are an example, and other examples are not limited thereto.

Even if the identical information x is input to the first neural network model 410, the first neural network model 420 and the first neural network model 430, a plurality of pieces of output information may not be identical. Accordingly, the mean and the variance of the plurality of pieces of output information may be determined for each of the plurality of first neural network models. Here, the information x may include various information samples.

For example, when the information x is input to the first neural network model 410, the mean of the plurality of pieces of output information of the first neural network model 410 corresponds to μ_{y}_{₁}, and the variance of the plurality of pieces of output information may correspond to σ_{y}_{₁}². Further, when the information x is input to the first neural network model 420, the mean of the plurality of pieces of output information of the first neural network model 420 corresponds to μ_{y}_{₂}, and the variance of the plurality of pieces of output information may correspond to σ_{y}_{₂}². Further, when the information x is input to the first neural network model 430, the mean of the plurality of pieces of output information of the first neural network model 430 corresponds to μ_{y}_{₃}, and the variance of the plurality of pieces of output information may correspond to σ_{y}_{₃}².

Here, when the mean and variance of the plurality of pieces of output information of the plurality of first neural network models are determined, the first uncertainty and the second uncertainty may be estimated from these values.

Specifically, the mean 440, which is μ_{y} may be determined based on the mean μ_{y}_{₁} of the plurality of pieces of output information of the first neural network model 410, the mean μ_{y}_{₂} of the plurality of pieces of output information of the first neural network model 420, and the mean μ_{y}_{₃} of the plurality of pieces of output information of the first neural network model 430. In other words, the mean μ_{y} 440 may be the mean of μ_{y}_{₁}, μ_{y}_{₂} and μ_{y}_{₃}.

In addition, the variance 450, which is var(μ_{y}), may be determined based on the mean μ_{y}_{₁} of the plurality of pieces of output information of the first neural network model 410, the mean μ_{y}_{₂} of the plurality of pieces of output information of the first neural network model 420, and the mean μ_{y}_{₂} of the plurality of pieces of output information of the first neural network model 430. In other words, the variance var(μ_{y}) 450 may correspond to the variance of μ_{y}_{₁}, μ_{y}_{₂} and μ_{y}_{₃}.

Next, the mean 460, which is mean(σ_{y}²), may be determined based on the variance σ_{y}_{₁}² of the plurality of pieces of output information of the first neural network model 410, the variance σ_{y}_{₂}² of the plurality of pieces of output information of the first neural network model 420, and the variance σ_{y}_{₃}² of the plurality of pieces of output information of the first neural network model 430. In other words, the mean(σ_{y}²) 460 may correspond to the mean of σ_{y}_{₁}², σ_{y}_{₂}² and σ_{y}_{₃}².

In an example, var(μ_{y}) 450 may correspond to the uncertainty of the neural network model itself as the first uncertainty, and the mean(σ_{y}²) 460 may correspond to the uncertainty of the data itself input to the neural network model as the second uncertainty.

In other words, when the identical information x is input to a plurality of first neural network models 410, 420 and 430, the first uncertainty and the second uncertainty may be identified based on the plurality of pieces of output information. Here, the information x may include various information samples, represent a value with a large first uncertainty among various information samples, and it may identify which samples have small first uncertainty values.

The second neural network model may be generated with the application of a knowledge distillation using a distillation loss determined based on the first uncertainty and the second uncertainty identified based on the plurality of first neural network models 410, 420 and 430.

In order to apply the knowledge distillation, the distillation loss may be determined based on at least one of the first loss, the second loss, the first uncertainty and the second uncertainty.

In an example, the distillation loss may be determined based on the operation based on the first uncertainty, the first loss and the second loss, as shown in Equation 1 below. In other words, without the second uncertainty, the distillation loss may be determined based on the operation based on the first uncertainty, the first loss and the second loss.

$$distillation loss = first uncertainty * g ( first loss , second loss ) \qquad Equation 1$$

In an example, with respect to the plurality of first neural network models, weights may be adjusted upward for samples with high first uncertainty among its information samples. Specifically, for samples whose first uncertainty is greater than a threshold value, the weights may be adjusted upward. In other words, when a value of the first uncertainty is higher than a threshold value, the weights for the corresponding sample may be adjusted upward to increase the amount of learning across the plurality of first neural network models. Accordingly, the first uncertainty may be reduced.

In an example, the distillation loss may be determined based on the operations based on the first uncertainty, the second uncertainty, the first loss and the second loss, as shown below in Equation 2. In other words, the ratio between the first loss and the second loss may be controlled based on the second uncertainty, and the distillation loss may be determined based on the operation between the result value according to the control and the first uncertainty. For example, when the second uncertainty is high, the ratio of the first loss may be controlled to be increased compared to the second loss. In another example, when the second uncertainty is low, the ratio of the second loss may be controlled to be increased compared to the first loss. When a value of the second uncertainty exceeds 1, the value may be normalized to be between 0 and 1 and applied in Equation 2.

$$distillation loss = first uncertainty * \{ second uncertainty * first loss + ( 1 - second uncertainty ) * second loss \} \qquad Equation 2$$

Accordingly, when the first uncertainty is high with respect to the plurality of first neural network models, the weights of the information samples contained in the information x may be adjusted upwards overall. Specifically, when the first uncertainty is greater than the reference value, the weights of the information samples included in the information x may be adjusted upward overall. In other words, the weights may be adjusted upwards overall to increase the amount of training data for the information samples contained in the information x. Accordingly, the first uncertainty may be reduced.

Further, when the second uncertainty is high with respect to the plurality of first neural network models, the second neural network model may be created using the distillation loss, which places more weight on the first loss than on the second loss.

In an example, the distillation loss may be determined based on the operations with the first uncertainty, the second uncertainty, the first loss and the second loss, as shown below in Equation 3. In other words, the ratio between the first loss and the second loss may be controlled based on the second uncertainty, and the distillation loss may be determined based on the operation between the result value according to the control and the first uncertainty. For example, when the second uncertainty is high, the ratio of the second loss may be controlled to be increased compared to the first loss. In another example, when the second uncertainty is low, the ratio of the first loss to the second loss may be controlled to be increased.

$$distillation loss = first uncertainty * \{ second uncertainty * second loss + ( 1 - second uncertainty ) * first loss \} \qquad Equation 3$$

Here, when the first uncertainty is high with respect to the plurality of first neural network models, the weights of the information samples contained in the information x may be adjusted upwards overall. Specifically, when a value of the first uncertainty is greater than the reference value, the weights of the information samples included in the information x may be adjusted upward overall. In other words, the weights may be adjusted upwards overall to increase the amount of training data for the information samples contained in the information x. Accordingly, the first uncertainty may be reduced.

Further, when the second uncertainty is high with respect to the plurality of first neural network models, the second neural network model may be created using the distillation loss, which places more weight on the second loss than on the first loss.

In an example, when the second uncertainty is greater than the threshold value, as in Equation 4 below, the distillation loss may be determined based on the operation between the first uncertainty and the first loss. In other words, the distillation loss may be determined based on the operation between the first uncertainty and the first loss, without the second loss and the second uncertainty. Accordingly, the threshold value may be set differently based on the characteristics of the field to which the neural network model is applied.

$$distillation loss = first uncertainty * g ( first loss ) \qquad Equation 4$$

In an example, the first uncertainty and the second uncertainty may be estimated corresponding to the number (i.e., an amount) of input information. For example, when one image information is the input information, one first uncertainty and one second uncertainty may be estimated for one image information.

Alternatively, the first uncertainty and the second uncertainty may be estimated for each piece of information that requires an estimation of the uncertainty contained in the input information, regardless of the number of input information. For example, when a single image information consisting of multiple pixels (for example, 100*100) is input as the input information, each of the first uncertainty and the second uncertainty may be estimated for each pixel included in the image information. In this case, the distillation loss according to Equation 1 to Equation 4 described above may be determined for each (x, y) coordinate corresponding to a pixel.

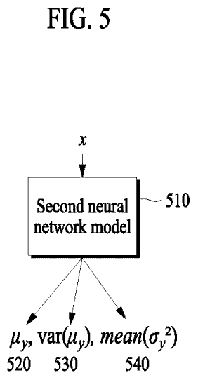

In other words, the first uncertainty and the second uncertainty are estimated based on the number of input information, or the first uncertainty and the second uncertainty may be estimated for each piece of information that requires estimation of the uncertainty contained in the input information. Therefore, the second neural network model may be generated as illustrated in FIG. 5 based on the knowledge distillation using the distillation loss determined by a combination of one or more of the examples described above.

FIG. 5 illustrates an example method of generating a second neural network model generated based on a knowledge distillation according to one or more embodiments.

In an example where the number of second neural network models is less than the number of the plurality of first neural network models, and thus when a second neural network model is used, the inference time may be reduced compared to a first neural network model. For example, the inference time may be reduced most efficiently when there is only one second neural network model. However, examples may include cases where there is more than one second neural network model.

Referring to FIG. 5, in a non-limiting example, when information x is input to the second neural network model 510, μ_{y} 520, var(μ_{y}) 530 and mean(σ_{y}²) 540 may be output. On the other hand, referring to FIG. 4, the values μ_{y} 440, the var(μ_{y}) 450 and the mean(σ_{y}²) 460 are estimated based on the plurality of pieces of output information of the plurality of first neural network models 410, 420 and 430, while in FIG. 5, the values μ_{y} 520, the var(μ_{y}) 530 and mean(σ_{y}²) 540 are estimated based on the single second neural network model 510.

In an example, the var(μ_{y}) 530 corresponds to the first uncertainty of the second neural network model 510, and the mean(σ_{y}²) 540 may correspond to the second uncertainty of the second neural network model 510. In comparison to FIG. 4, where the plurality of first neural network models are required, the first uncertainty and the second uncertainty illustrated in FIG. 5, may be identified through a small number of the neural network models (i.e., a sing second neural network model 510).

The value var(μ_{y}) 530 from the second neural network model 510 may be reduced compared to the value var(μ_{y}) 450 of FIG. 4 which was obtained from the plurality of first neural network models 410, 420, and 430. In other words, the distillation loss may be determined so that the first uncertainty is reduced, and the first uncertainty identified in the second neural network model 510 generated by the knowledge distillation using the distillation loss may be reduced compared to the first uncertainty identified based on the plurality of first neural network models.

By improving the first uncertainty and training the second neural network model by reflecting the second uncertainty of the plurality of first neural network models, the accuracy of the second neural network model may be improved compared to the plurality of first neural network models. In other words, the first uncertainty may be reduced as the accuracy of the output of the second neural network model is improved compared to the output of the plurality of first neural network models.

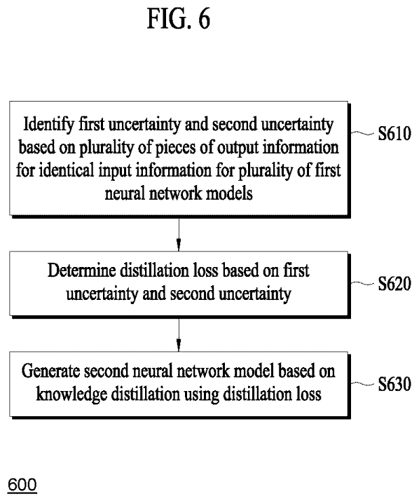

FIG. 6 illustrates an example method of model generation according to one or more embodiments.

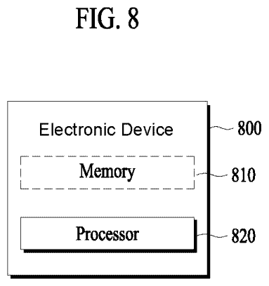

Referring to FIG. 6, in a non-limiting example, a method 600 is illustrated. In the method 600, in operation S610, a computational device (e.g., electronic device 800 of FIG. 8) may identify a first uncertainty and a second uncertainty based on a plurality of pieces of output information for identical input information applied to each of a plurality of first neural network models. As described above, for an uncertainty associated with the plurality of first neural network models, the first uncertainty is the uncertainty of the neural network model itself. On the other hand, the second uncertainty is uncertainty due to noise inherent in the input information.

Accordingly, the means of the plurality of pieces of output information corresponding to each of the plurality of first neural network models may be identified, and the first uncertainty based on the variance of the corresponding means of the plurality of first neural network models (e.g., first neural network models 410, 420, and 430) may also be identified. For example, referring to FIG. 4, the computational device may identify the mean, which is μ_{y}_{₁}, of the plurality of pieces of output information corresponding to the first neural network model 410, the mean, which is μ_{y}_{₂}, of the plurality of pieces of output information corresponding to the first neural network model 420, and the mean, which is μ_{y}_{₃}, of the plurality of pieces of output information corresponding to the first neural network model 430, and thus, the computational device may identify the first uncertainty based on the variance of the mean values μ_{y}_{₁}, μ_{y}_{₂} and μ_{y}_{₃}.

Further, the variances of the plurality of pieces of output information corresponding to each of the plurality of first neural network models may be identified, and the second uncertainty may be identified based on the mean of the corresponding variances of the plurality of first neural network models. For example, referring to FIG. 4, the computational device may identify the variance, which is σ_{y}_{₁}², of the plurality of pieces of output information corresponding to the first neural network model 410, the variance, which is σ_{y}_{₂}² of the plurality of pieces of output information of the first neural network model 420, and the variance, which is σ_{y}_{₃}² of the plurality of pieces of output information of the first neural network model 430, and the computational device may identify the second uncertainty based on the mean of variance σ_{y}_{₁}², variance σ_{y}_{₂}² and variance σ_{y}_{₃}².

In an example, in operation S620, the computational device (e.g., electronic device 800) may determine a distillation loss based on the first uncertainty and the second uncertainty. Specifically, the distillation loss may be determined based on at least one of the first uncertainty, the second uncertainty, the first loss and the second loss. Here, the first loss may correspond to the difference between the GT information corresponding to the input information and the output information of a second neural network model (e.g., second neural network model 510), and the second loss may correspond to the difference between output information of first neural network model (e.g., first neural network models 410, 420, and 430) and output information of the second neural network model.

In an example, the computational device may determine the distillation loss based on the operation between the first uncertainty, the first loss, and the second loss, as described above with respect to Equation 1. In other words, the computational device may determine the distillation loss based on the operation between the first uncertainty, the first loss and the second loss, without the second uncertainty.

In an example, the computational device may determine the distillation loss based on the operations based on the first uncertainty, the second uncertainty, the first loss and the second loss, as described above with respect to Equation 2 and Equation 3. In other words, the ratio between the first loss and the second loss may be controlled based on the second uncertainty, and the distillation loss may be determined based on the operation between the result value according to the control and the first uncertainty.

In an example, the computational device may determine the distillation loss based on the operation between the first uncertainty and the first loss, without the second loss and the second uncertainty, as described above with respect to Equation 4. Here, when the second uncertainty is greater than the threshold value, the distillation loss may be determined based on the operation between the first uncertainty and the first loss, and the threshold value may be set differently based on the characteristics of the field to which the neural network model is applied.

In an example, in operation S630, the computational device (e.g., electronic device 800) may generate a second neural network model (e.g., second neural network model 510) based on a knowledge distillation using the distillation loss.

Here, the number of second neural network models may be less than the number of plurality of first neural network models (e.g., first neural network models 410, 420, and 430). Accordingly, since it takes more time to identify the first uncertainty and the second uncertainty using the plurality of first neural network models, by using a smaller number of second neural network models, the first uncertainty and the second uncertainty may be identified in less time. Further, the first uncertainty of the second neural network model may be reduced compared to the first uncertainty identified based on the plurality of first neural network models.

Accordingly, by training the second neural network model by reflecting the second uncertainty of the plurality of first neural network models, the accuracy of the second neural network model may be improved compared to the plurality of first neural network models.

In an example, a performance of an optical proximity correction (OPC) model and/or a process proximity correction (PPC) model in a semiconductor manufacturing process may be improved when employing the above-described methods. In other words, the first uncertainty and prediction error identified by applying a second neural network model (e.g., second neural network model 510) to the OPC model and/or the PPC model may be improved more than identifying a first uncertainty and prediction error by applying a plurality of first neural network models (e.g., first neural network models 410, 420, and 430) to the OPC model and/or the PPC model. In addition, by applying the second neural network model, an inference time may also be reduced.

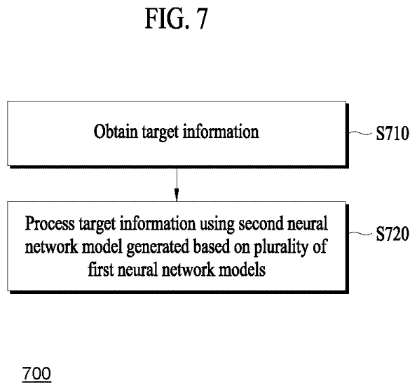

FIG. 7 illustrates an example method of information processing using a neural network model according to one or more embodiments.

Referring to FIG. 7, in a non-limiting example, a method 700 is illustrated. In the method 700, in an example, operation S710, an electronic device (e.g., electronic device 800) may obtain target information. In an example, in operation S720, the electronic device may process the target information using a second neural network model (e.g., second neural network model 510) generated based on a plurality of first neural network models (e.g., first neural network models 410, 420, and 430). The electronic device may include the computational device described above to perform, for example, the method 600 of FIG. 6.

Here, the second neural network model may be a model that has an uncertainty (i.e., a first uncertainty of the second neural network model) that is less than uncertainties corresponding to the plurality of first neural network models (i.e., first uncertainties of the first neural network models). That is, the uncertainties are distinguished between the first uncertainty associated with the plurality of first neural network models and the second uncertainty due to noise inherent in the training data. For reference, the above example embodiments may be applied to neural network models.

FIG. 8 illustrates an example electronic device according to one or more embodiments.

Referring to FIG. 8, in a non-limiting example, a electronic device 800 may include memory 810 and a processor 820. The memory 810 may be contained within the electronic device 800, but is not limited thereto and may be located external to the electronic device 800. The processor 820 may be configured to execute programs or applications to configure the processor 820 to control the electronic apparatus 800 to perform one or more or all operations and/or methods involving estimating uncertainties from first and second neural network models, and may include any one or a combination of two or more of, for example, a central processing unit (CPU), a graphic processing unit (GPU), a neural processing unit (NPU) and tensor processing units (TPUs), but is not limited to the above-described examples.

It will be understood by those skilled in the art that other general components may be included in addition to the components illustrated in FIG. 8, as described herein. The above-described contents may be applied to electronic device 800, so any repeated description is omitted.

The memory 810 may include computer-readable instructions. The processor 820 may be configured to execute computer-readable instructions, such as those stored in the memory 810, and through execution of the computer-readable instructions, the processor 200 is configured to perform one or more, or any combination, of the operations and/or methods described herein. The memory 810 may be a volatile or nonvolatile memory.

In an example, based on computation of output information for the identical input information among a plurality of first neural network models (e.g., first neural network models 410, 420, and 430), the processor 820 may identify a first uncertainty associated with the plurality of first neural network models and a second uncertainty due to noise inherent in the input information, the processor 820 may determine a distillation loss based on the first uncertainty and the second uncertainty, and generate a second neural network model (e.g., second neural network model 510) based on a knowledge distillation using the distillation loss.

In an example, the processor 820 may identify the means of a plurality of pieces of output information corresponding to each of the plurality of first neural network models, and identify the first uncertainty based on the variance of the corresponding means of the plurality of first neural network models.

In an example, the processor 820 may identify the variances of the plurality of pieces of output information corresponding to the plurality of first neural network models, and identify the second uncertainty based on the mean of the corresponding variances of each of the plurality of first neural network models.

In an example, the processor 820 may determine the distillation loss based on either the first loss that corresponds to the difference the GT information corresponding to the first uncertainty, the second uncertainty and input information and the output information of the second neural network model, or the second loss that corresponds to the difference between the output information of the first neural network model and the output information of the second neural network model.

In an example, the processor 820 may determine the distillation loss based on an operation based on the first uncertainty, the first loss and the second loss. For example, the processor 820 may control the ratio between the first loss and the second loss based on the second uncertainty, and determine the distillation loss based on the first uncertainty and the controlled value based on the second uncertainty. In addition, the processor 820 may determine the distillation loss based on the operation between the first uncertainty and the first loss when the second uncertainty is greater than the threshold value.

The processor 820 may generate a smaller number of second neural network models than the number of the plurality of first neural network models. In an example, the processor 820 may generate a single second neural network model based on the plurality of first neural network models.

A second neural network model may be generated based on the knowledge distillation using the distillation loss determined by a combination of one or more of the example embodiments described above. The processor 820 may generate a second neural network model with a reduced first uncertainty compared to the first uncertainty corresponding to the plurality of first neural network models based on the knowledge distillation using the distillation loss.

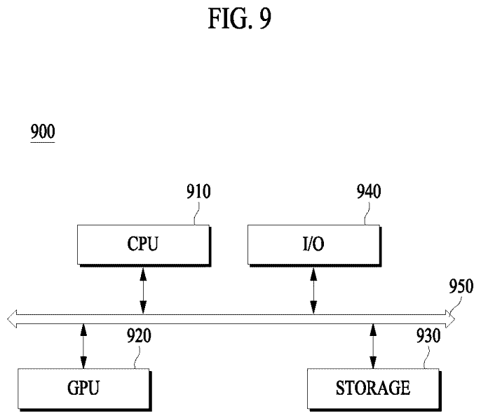

FIG. 9 illustrates an example computing system including a computational device according to one or more embodiments.

It will be understood by those skilled in the art that computing system 900 may further include other general purpose components in addition to the components illustrated in FIG. 9. The computing system 900 may correspond to an electronic device (e.g., electronic device 800) that performs the aforementioned information processing method. The above example embodiments may be applied to the computational device included in the computing system 900, and thus repeated description is omitted.

Referring to FIG. 9, in a non-limiting example, the computing system 900 may include a CPU 910, a GPU 920, a storage 930, an I/O (Input/Output) device 940 and data bus 950.

The CPU 910 may execute software (application programs, operating system and so on) and process data to be run on the computing system 900. The GPU 920 may perform various graphics operations and/or parallel processing operations. In other words, the GPU 920 may have a structure that is advantageous for parallel processing, which processes similar operations repeatedly. Therefore, the graphic processing strategy 920 may be used for various operations requiring high-speed parallel processing as well as graphic operations. Accordingly, the GPU 920 may efficiently process operations used in model generation methods and information processing methods using neural network models.

The storage 930 may correspond to a storage medium of a neural network model. The storage 930 may store the first neural network model, the second neural network model, application programs, operating system images (OS images), and various related information. Additionally, the storage 930 may store and update information of the generated second neural network model.

The storage 930 may be provided as a memory card (MMC, eMMC, SD, MicroSD and so on) or a hard disk drive (HDD). The storage 930 may include NAND-type flash memory having a large storage capacity. Further, the storage 930 may transmit and receive data with the CPU 910 and GPU 920 and store data and/or commands required for program execution. Here, the storage 930 may be a volatile memory device such as dynamic random access memory (DRAM), synchronous dynamic random access memory (SDRAM), double data rate (DDR) DRAM, DDR SDRAM, low power double data rate (LPDDR) SDRAM, graphics double data rate (GDDR) SDRAM, Rambus dynamic random access memory (RDRAM), static random access memory (SRAM) and so on. The storage 930 may also be implemented in non-volatile memory devices such as resistive random access memory (RRAM), phase-change random access memory (PRAM), magnetoresistive random access memory (MRAM), ferroelectric RAM (FRAM), and spin transfer torque RAM (STT-RAM).

The I/O device 940 may include at least one input device configured to receive data, such as a mouse and a keyboard, and may include at least one output device configured to output data, such as a monitor, a speaker and a printer.

The CPU 910, the GPU 920, the storage 930 and the I/O device 940 may be coupled to each other via a data bus 950. The data bus 950 may correspond to a path through which data is moved. The configuration of the data bus 950 is not limited thereto and may further include arbitration devices for efficient management.

The neural networks, processors, memories, computation devices, electronic devices, neural networks, first neural network models 110, 220,310, 320, 330, 410, 420, and 430, second neural network models 120, 230, and 510, electronic device 800, memory 810, processor 820, computation device 900, CPU 910, GPU 920, Storage 930, and I/O interface 940 described herein and disclosed herein described with respect to FIGS. 1-9 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
identifying a first uncertainty associated with a plurality of first neural network models based on a plurality of pieces of output information obtained from identical input information for each model of the plurality of first neural network models and a second uncertainty due to noise in the input information;
determining a distillation loss based on the first uncertainty and the second uncertainty; and
generating a second neural network model based on knowledge distillation using the distillation loss.

2. The method of claim 1, wherein the identifying the first uncertainty and the second uncertainty comprises:
identifying respective means of a plurality of pieces of output information corresponding to each of the plurality of first neural network models; and
identifying the first uncertainty based on respective variances of the respective means corresponding to each of the plurality of first neural network models.

3. The method of claim 2, wherein the identifying the first uncertainty and the second uncertainty further comprises:
identifying respective variances of the plurality of pieces of output information corresponding to each of the plurality of first neural network models; and
identifying the second uncertainty based on a mean of the respective variances corresponding to each of the plurality of first neural network models.

4. The method of claim 3, wherein the determining the distillation loss comprises determining the distillation loss based one or more of:
the first uncertainty;
the second uncertainty;
a first loss corresponding to a first difference between ground-truth (GT) information corresponding to the input information provided to the second neural network model and output information of the second neural network model; and
a second loss corresponding to a second difference between the output information of the first neural network models and the output information of the second neural network model.

5. The method of claim 4, wherein the determining the distillation loss comprises determining the distillation loss based on calculation based on the first uncertainty, the first loss and the second loss.

6. The method of claim 4, wherein the determining the distillation loss further comprises:
controlling a ratio between the first loss and the second loss based on the second uncertainty; and
determining the distillation loss based on a first value of the first uncertainty and an adjusted ratio between the first loss and the second loss based on the second uncertainty.

7. The method of claim 4, wherein the determining the distillation loss further comprises:
determining the distillation loss based on calculation between the first uncertainty and the first loss responsive to a second value of the second uncertainty being greater than a threshold value.

8. The method of claim 1, wherein the generating the second neural network model comprises generating a plurality of second neural network models, wherein a first number of first neural network models is greater than a second number of the plurality of second neural network models.

9. The method of claim 1, wherein the generating the second neural network model comprises:
generating the second neural network model having a first uncertainty, based on the knowledge distillation using the distillation loss, the first uncertainty of the second neural network model being lower than the first uncertainty of the plurality of first neural network models.

10. A non-transitory computer-readable recording medium having a program for executing the method of claim 1 on a computer.

11. An electronic device, comprising:
a processor configured to execute instructions; and
a memory storing the instructions, wherein execution of the instructions configures the processors to:
identify a first uncertainty associated with a plurality of first neural network models based on a plurality of pieces of output information obtained from identical input information for each model of the plurality of first neural network models and a second uncertainty due to noise inherent in the input information;
determine a distillation loss based on the first uncertainty and the second uncertainty; and
generate a second neural network model based on knowledge distillation using the distillation loss.

12. The electronic device of claim 11, wherein the processor is further configured to:
identify respective means of a plurality of pieces of output information corresponding to each of the plurality of first neural network models; and
identify the first uncertainty based on respective variances of the respective means corresponding to each of the plurality of first neural network models.

13. The electronic device of claim 12, wherein the processor is further configured to:
identify respective variances of the plurality of pieces of output information corresponding to each of the plurality of first neural network models; and
identify the second uncertainty based on a mean of the respective variances corresponding to each of the plurality of first neural network models.

14. The electronic device of claim 13, wherein the processor is further configured to determine the distillation loss based on one or more of:
the first uncertainty;
the second uncertainty;
a first loss corresponding to a first difference between GT information corresponding to the input information provided to the second neural network model and output information of the second neural network model; and
a second loss corresponding to a second difference between the output information of the first neural network models and the output information of the second neural network model.

15. The electronic device of claim 14, wherein the processor is further configured to:
determine the distillation loss based on calculation based on the first uncertainty, the first loss and the second loss.

16. The electronic device of claim 14, wherein the processor is further configured to:
control a ratio between the first loss and the second loss based on the second uncertainty; and
determine the distillation loss based on a first value of the first uncertainty and an adjusted ratio between the first loss and the second loss based on the second uncertainty.

17. The electronic device of claim 14, wherein the processor is further configured to:
determine the distillation loss based on calculation between the first uncertainty and the first loss responsive to a second value of the second uncertainty being greater than a threshold value.

18. The electronic device of claim 11, wherein the processor is further configured to:
generate a second number of a plurality of second neural network models, the second number being less than a first number of the plurality of first neural network models.

19. The electronic device of claim 11, wherein the processor is further configured to:
generate the second neural network model having a first uncertainty, based on the knowledge distillation using the distillation loss, the first uncertainty of the second neural network model being lower than the first uncertainty of the plurality of first neural network models.

20. A processor-implemented method, the method comprising:
obtaining target information; and
processing the target information using a second neural network model that is generated based on a plurality of first neural network models,
wherein the second neural network model has a first uncertainty, the first uncertainty of the second neural network model being less thana first uncertainty of a plurality of first neural network models, between the first uncertainty of the plurality of first neural network models and a second uncertainty due to noise in training data.
